(19) United States
(12) Patent Application Publication
(10) Pub. No.: US 2004/0001109 A1
(43) Pub. Date: Jan. 1, 2004

(54) Drop down checklist control

(75) Inventors: Brad L. Blancett, Raleigh, NC (US); George P. DeCandio, Apex, NC (US); L. Scott Rich, Apex, NC (US); Lucinio Santos-Gomez, Durham, NC (US); Rebecca J. Schaller, Cary, NC (US); David M. Slubicki, Chapel Hill, NC (US)

Correspondence Address: Steven M. Greenberg, Esquire, Akerman Senterfitt & Eidson, P.A., Post Office Box 3188, West Palm Beach, FL, 33401-3188, US

(73) Assignee: International Business Machines Corporation, Armonk, NY

(21) Appl. No.: 10/185,595

(22) Filed: Jun. 27, 2002

(51) Int. Cl. G09G 5/00

(52) U.S. Cl. 345/843; 345/845; 345/809

(57) ABSTRACT

A drop down checklist control. The drop down checklist control can include an activatable label and a drop down list visually coupled to the label. The drop down list can be collapsed from view until the activatable label has been activated. A checklist of mutually non-exclusive checklist entries can be disposed in the drop down list. Finally, a selectable submit control can be disposed in the drop down list, wherein the drop down list control can become collapsed from view upon selection of the submit control.

### BACKGROUND OF THE INVENTION

1. Statement of the Technical Field

The present invention relates to the field of graphical user interfaces and more particularly to the manipulation of a check list in a graphical user interface.

2. Description of the Related Art

The conventional graphical user interface (GUI) has been widely used for many years. The primary function of the GUI includes providing visual controls with which the end-user can interact with an underlying application. Though the common GUI includes many stock visual controls, a select few visual controls can be combined to accommodate most computer-human interactions required by an application.

For example, the static text box control can be used to present text to the end-user while an edit box can permit the user to provide textual input to the application. A radio button control can provide for the exclusive selection of an element from among a field of elements, while a checklist box can control can provide for the non-exclusive selection of elements from among a field of elements. Notably, many visual controls can be combined in a combo box to produce a composite visual control.

In many graphical applications, oftentimes it is necessary for the end user to select one or more parameters for performing an operation. For example, compiler option parameters can be applied to the compilation of a computer program. Similarly, filter parameters can be applied to the performance of a search. Parameters ordinarily can be selected in this manner by embedding the parameter choices in a list in the GUI. In that regard, FIG. 3A illustrates the common case of a Web application 330 viewed through a Web browser 310. The Web application 330 can include an embedded checklist 350 with which an end user can select individual parameters using a pointing element 320. Once the individual parameters have been selected, the user can apply the selected parameters to the operation of the Web application 330 by selecting a corresponding submit button 340.

Still, as will be recognized by a cursory inspection of the Web application 330 of FIG. 3A, the embedding of a checklist 350 in the Web application 330 can consume valuable screen “real estate” which otherwise could host additional visual display elements. In consequence, where screen real estate is scarce relative to the information which must be displayed in a Web application 330, a separate dialog box can host the checklist 350 as shown in FIG. 3B. In the alternate case shown in FIG. 3B, a separate dialog box 370 can host the checklist 350 which can be applied to the Web application 330 responsive to the activation of the OK button 360. The dialog box 370, itself, can be invoked through the selection of the hyperlink 380.

Nevertheless, as will be recognized by one of ordinary skill in the art, the use of a separate dialog box through which a checklist can be presented first requires the additional management burden of interacting with the dialog box (opening, placing and closing the dialog box in the GUI). Also, the use of a separate dialog box through which a checklist can be presented requires separate coding and maintenance of the dialog box, and second requires the activation of the dialog box which can be drawn in a position not necessarily related to the underlying application. Hence, the use of the dialog box can distract the end user from the primary task at hand. Accordingly, what is needed is an efficient, minimal visual control through which a selection of parameters can be applied to an underlying application.

### SUMMARY OF THE INVENTION

The present invention is a drop down checklist control. The drop down checklist control can overcome the deficiencies of the prior art by providing a novel and nonobvious minimal visual control through which a selection of parameters can be applied to an underlying application while involving minimal movement of a pointing device. In a preferred aspect of the present invention, a drop down checklist control article of manufacture can include an activatable label. A drop down list can be visually coupled to the activatable label, but collapsed from view until the label has been activated. A checklist of mutually non-exclusive checklist entries can be disposed in the drop down list. Finally, a selectable submit control can be disposed in the drop down list, wherein the drop down list can become collapsed from view upon selection of the submit control. Upon collapsing the view of the drop down list, the checklist entries can be applied to the underlying application.

A method for applying selected parameters to the operation of a computer application, can include, responsive to the selection of an activatable portion of a label, configuring a checklist with a plurality of checklist entries, and further configuring a drop down list with the checklist and with a submit control. The configured drop down list can be positioned adjacent to or upon the label or a portion of the label. Once positioned, the drop down list can be displayed, and individual ones of the checklist entries can be selected. Finally, responsive to the selection of the submit control, the selected individual ones of the checklist entries can be provided to the computer application and the configured drop down list can be collapsed from view.

### BRIEF DESCRIPTION OF THE DRAWINGS

There are shown in the drawings embodiments which are presently preferred, it being understood, however, that the invention is not limited to the precise arrangements and instrumentalities shown, wherein:

FIGS. 1A through 1C, collectively, illustrate the use of a drop down list control in a GUI;

FIG. 2 is a flow chart illustrating a process for managing the drop down list control of FIG. 1;

FIG. 3A is a pictorial illustration of a GUI known in the art which has been configured with a check list; and,

FIG. 3B is a pictorial illustration of a GUI known in the art which has been configured with a dialog box for hosting a check list.

### DETAILED DESCRIPTION OF THE PREFERRED EMBODIMENTS

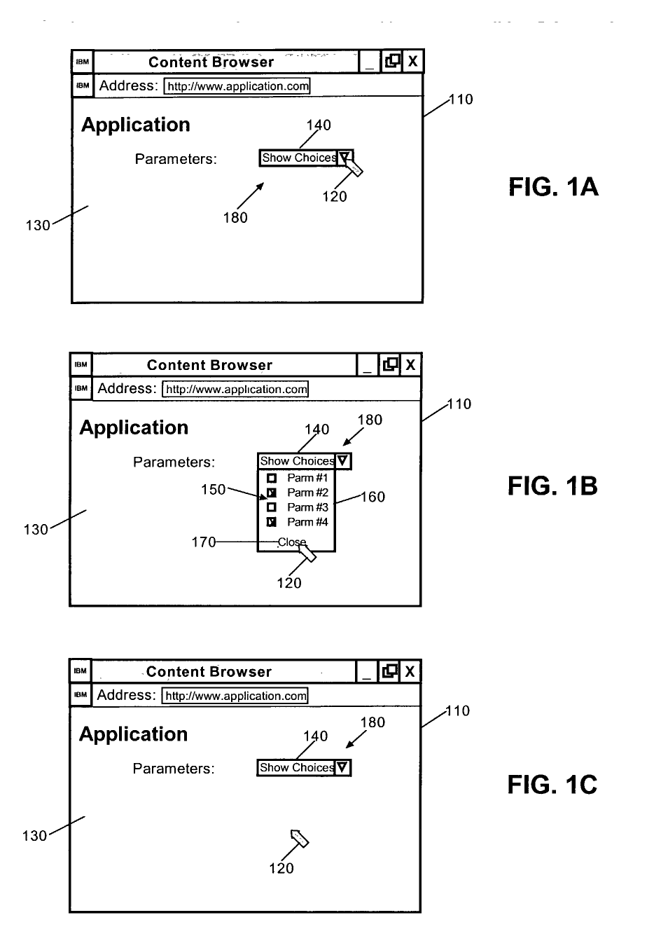

The present invention is a drop down checklist control which consumes minimal screen real estate while requiring little pointing device manipulation to effectively select and apply parameters to the operation of an application. FIGS. 1A through 1C, collectively, illustrate the use of a drop down checklist control in a GUI. In particular, FIG. 1A illustrates a content browser 110 hosting an application 130. The application 130 can include a drop down checklist control 180 which can be activated by selecting an activatable label 140 through the use of a pointing device 120. Importantly, thought the application 130 illustrated in FIG. 1A includes a content browser 110 for facilitating the presentation and operation of the application 130, the invention is not so limited. Rather, in other equally preferably embodiments of the present invention, the application 130 can be a standalone graphical application as is well-known in the art.

FIG. 1B depicts the activation of the drop down checklist control 180. Specifically, upon activation, a drop down list 160 can be displayed in the application 130. The drop down list 160, unlike conventional drop down list controls, can include a checklist control 150 and a submit control 170. The check list control 150 can include multiple selectable parameters which can be considered in the operation of the application 130. For example, the multiple selectable parameters can include filter terms to be applied to a filter in a search operation, or compilation rules to be applied during the compilation of a computer program. Moreover, additional controls (not shown) can be included in association with the checklist control 150 such as a select all control, a deselect all control, a default control, etc. In any case, upon selecting the submit control 170, the selected parameters can be passed to the application 130 for further processing, and, as shown in FIG. 1C, the drop down list 160 can be collapsed leaving only the activatable label 140 visible.

Importantly, as will be apparent to one skilled in the art, several advantages can be realized through the incorporation of the drop down checklist control 180 of the present invention. First, when only the activatable label portion 140 of the drop down checklist control 180 is visible while the drop down list 160 containing the checklist control 150 remains collapsed, minimal screen real estate in the application 130 is consumed. Moreover, inasmuch as the drop down checklist control 180 includes an activatable label 140, no additional static text control will be required to label the drop down checklist control 180.

It will also be apparent that the use of the drop down checklist control 180 requires minimal movement of the pointing device 120 as the checklist control 150 and submit control 170 are positioned proximately to the activatable label portion 140 of the drop down checklist control 180. By comparison, in a convention dialog box implementation of a checklist, the placement of the dialog box relative to the control which activates the dialog box can be random and distant. Finally, management of the entries included in the checklist control 170 can be easier than managing entries which are displayed in a separate dialog box. In particular, it is well known that separate windows often are associated with separate modules of an application. The modification of entries in the checklist control 170 of the present invention, however, requires simply the inclusion of the entries when constructing the drop down checklist control 140.

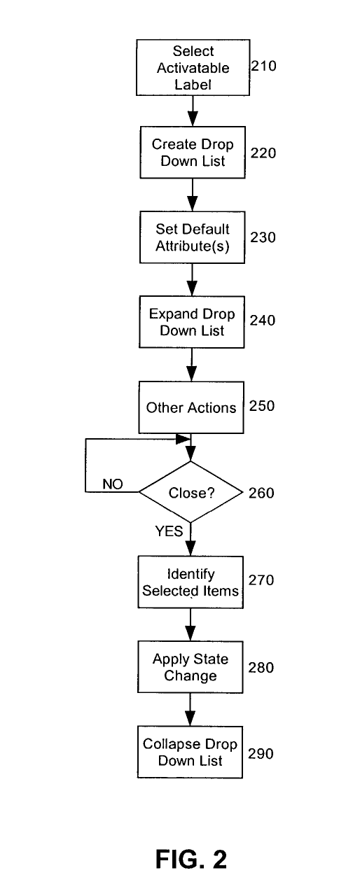

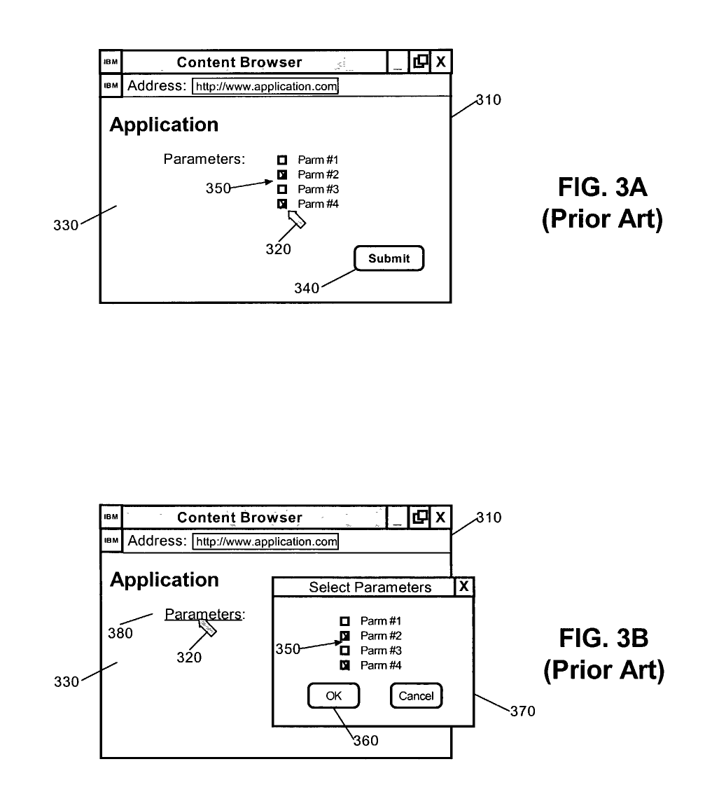

FIG. 2 is a flow chart illustrating a process for managing the drop down checklist control of FIG. 1. Beginning in block 210, the activatable label portion of a drop down checklist control can be selected. Though not strictly limited to any particular manner of selection, in a preferred aspect of the invention, the activatable label portion of the drop down checklist control can be selected in a manner similar to the activation of a conventional drop down list control. In block 220, responsive to the selection of the activatable label, a drop down list can be created and a checklist control can be included within the drop down list. Additionally, in block 230, one or more default attributes of the checklist control and the drop down list can be set, such as whether certain parameters are selected by default. In block 240, the configured and fully activated drop down list can be displayed (e.g. expanded) in the application.

In block 250, once the drop down checklist control has been fully expanded, one or more of the checklist items in the checklist can be selected or deselected. Furthermore, other actions can be applied to the checklist such as a select all or deselect all operation. In any case, in decision block 260, it can be determined whether the submit control has been selected. Specifically, when the end user has completed selecting particular items in the check list, the end user can select a submit button which can be labeled, for instance, “close” or “submit”, etc.

When the submit button has been selected, in block 270 the items which have been selected can be identified and in block 280, the selected parameters can be passed to the application to be applied to the operation thereof. Alternatively, an array or list of all parameters in the checklist, selected or otherwise, can be passed to the application with an indication of the state of each parameter. In any case, once the parameters in the checklist have been passed to the application, in block 290 the drop down list can be collapsed from view.

Notably, the present invention can be realized in software as a graphical component, or can be included as a visual control content element in distributable content such as a Web page. In either case, the visual control can be implemented in a centralized fashion in one computer system, or in a distributed fashion where different elements are spread across several interconnected computer systems. Any kind of computer system, or other apparatus adapted for carrying out the methods described herein, is suited to perform the functions described herein.

A typical centralized implementation could include a general purpose computer system with a computer program that, when being loaded and executed, controls the computer system such that it carries out the methods described herein. Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

We claim:

1. A drop down checklist control article of manufacture, comprising:
an activatable label;
a drop down list visually coupled to said activatable label, but collapsed from view until said activatable label has been activated;
a checklist of mutually non-exclusive checklist entries disposed in said drop down list; and,
a selectable submit control disposed in said drop down list, said drop down list becoming hidden from view upon selection of said submit control.

2. The drop down checklist control article of manufacture of claim 1, wherein each of said activatable label, drop down list, checklist and submit control can be referenced in network distributable markup which can be processed in a content browser.

3. The drop down checklist control article of manufacture of claim 1, wherein each of said activatable label, drop down list, checklist and submit control can be referenced in a standalone application which can be processed by a personal computer.

4. The drop down checklist control article of manufacture of claim 1, wherein said activatable label denotes a characteristic common to all of said checklist entries disposed in said drop down list.

5. A method for applying selected parameters to the operation of a computer application, said method comprising the steps of:
responsive to the selection of an activatable portion of a label, configuring a checklist with a plurality of checklist entries, and further configuring a drop down list with said checklist and with a submit control;
positioning said configured drop down list adjacent to said label;
displaying said positioned drop down list;
selecting individual ones of said checklist entries; and,
responsive to the selection of said submit control, providing said selected individual ones of said checklist entries to the computer application and collapsing said configured drop down list.

6. The method of claim 5, wherein said collapsing step comprises the step of hiding said configured drop down list from view.

7. A machine readable storage having stored thereon a computer program for applying selected parameters to the operation of a computer application, said computer program comprising a routine set of instructions for causing the machine to perform the steps of:
responsive to the selection of an activatable portion of a label, configuring a checklist with a plurality of checklist entries, and further configuring a drop down list with said checklist;
positioning said configured drop down list adjacent to said label;
displaying said positioned drop down list control;
selecting individual ones of said checklist entries; and,
responsive to the selection of said submit control, providing said selected individual ones of said checklist entries to the computer application and collapsing said configured drop down list.

8. The machine readable storage of claim 7, wherein said collapsing step comprises the step of hiding said configured drop down list from view.
